(19) United States
(12) Patent Application Publication
(10) Pub. No.: US 2011/0006624 A1
(43) Pub. Date: Jan. 13, 2011

(54) DEVICE AND METHOD FOR GENERATING FORCE AND/OR MOVEMENT

(76) Inventor: Kari Kirjavainen, Tampere (FI)

Correspondence Address: LADAS & PARRY LLP, 26 WEST 61ST STREET, NEW YORK, NY, 10023, US

(21) Appl. No.: 12/922,386

(22) PCT Filed: Mar. 19, 2009
(86) PCT No.: PCT/FI2009/050210

§ 371 Date: Sep. 13, 2010

(30) Foreign Application Priority Data
Mar. 19, 2008 (FI) 20080223
Nov. 11, 2008 (FI) 20086068

(51) Int. Cl. H02K 11/00

(52) U.S. Cl. 310/66

(57) ABSTRACT

The invention relates to a device and a method for generating a force and/or a movement. The force and/or the movement are generated or the energy of the force and/or the movement is stored by utilizing a magnetic field. The magnetic field is generated with a charge current circuit (4) including a charge part and a structure generating the magnetic field without a separate winding. The charge current circuit (4) is used either to generate the magnetic field producing the force and/or the movement, or the force and/or the movement generates a variable magnetic field, the current induced by which is conducted to the charge part of the charge current circuit (4).

### BACKGROUND OF THE INVENTION

The invention relates to a device for generating a force and/or a movement or for storing the energy of a force and/or a movement by utilizing a magnetic field.

The invention also relates to a method of generating a force and/or a movement or for storing the energy of a force and/or a movement, the method utilizing a magnetic field.

In a typical electric motor, the stator and/or the rotor include a winding. Electric current is conducted to the winding from a separate current source, whereby the winding constituting a magnetic circuit generates a magnetic field, which is controlled in order for the electric motor to generate force and/or movement. Electric current is conducted to the winding from a current source, which may be a battery, a fuel cell or a corresponding current source. In addition, speed regulators, charging control devices and cablings between all these are required in the apparatus. The total weight of the apparatus becomes quite high, and, furthermore, the devices are relatively expensive as regards the costs thereof. In addition, effect losses are generated in each unit. The majority of the weight of the motor originates from the windings and quite a large part of the weights of the batteries, for example, originates from the encapsulation and fastenings thereof.

Publication U.S. 2007/0 187 952 discloses an electric motor in connection with a wheel of a bicycle. In the solution, a fixed, i.e. a non-rotating permanent magnet is arranged in connection with a wheel hub. A winding is rotationally arranged around the permanent magnets. Current is supplied to the winding from a current source, which may be a battery or a solar cell, for example. The current source is arranged to rotate along with the wheel. A variable electric field is generated with the winding for rotating the wheel. This solution includes the above-described components and drawbacks, i.e. there are many separate components, rendering the total solution quite heavy, and the acquisition costs of the apparatus quite high. A further problem is constituted by effect losses and cablings between the different units.

Publication U.S. 5 923 106 discloses a motor having a cylindrical, hollow stator and a cylindrical rotor arranged externally thereto. A fuel cell is arranged in the middle of the hollow stator. Current is conducted from the fuel cell with separate conductors to a current conductor disposed on the outer surface of the stator cylinder, the current conductor generating the motor torque.

Publication JP 5344664 discloses a solution in which alternating-current electric energy is temporarily stored in a rotating rotor as motion energy. The motion energy of the rotor is produced with the motor principle having conventional windings. Correspondingly, the energy of the rotating rotor is converted into alternating-current electricity. The applications of such a solution are quite limited.

### BRIEF DESCRIPTION OF THE INVENTION

It is the object of the present invention to provide a new type of method and device for generating a force and/or a movement or for storing the energy of a force and/or a movement.

The device of the invention is characterized in that the device comprises a charge current circuit including a charge part and a structure, which generates the magnetic field without a separate winding, whereby a magnetic circuit generates the magnetic field producing the force and/or the movement, or the force and/or the movement produces a variable magnetic field, the current induced by which being conducted to the charge part of the charge current circuit.

Furthermore, the method of the invention is characterized by generating the magnetic field with a charge current circuit including a charge part and a structure, which generates the magnetic field without a separate winding, whereby either a magnetic circuit is used to generate the magnetic field producing the force and/or the movement, or the force and/or the movement produces a variable magnetic field, the current induced by which being conducted to the charge part of the charge current circuit.

The idea of the invention is that the device comprises a charge current circuit including a charge part and a structure, which generates a magnetic field without a separate winding. When switched on, the charge current circuit generates a magnetic field that produces a force and/or a movement or the force and/or the movement produces a variable magnetic field, the current induced by which being conducted to the charge part of the charge current circuit. In the device, the charge current circuit generates the magnetic field at a position where the strength of the magnetic field is to be controlled. Accordingly, in the device, the charge current circuit is positioned in such a manner and made from such a material that the field lines describing the magnetic field pass via the charge current circuit. Consequently, as such, at the position where it is located, the charge current circuit generates the magnetic field or the magnetic fields required by the device. Thus, the current generated by the charge current circuit does not have to be conducted with separate conductors, for example, to a separate winding generating the magnetic field. Accordingly, one component, i.e. the charge current circuit, has at least two functions, i.e. generating or charging current and producing a magnetic field. The structure of the device is quite simple, and the number of cablings connecting the different units can be reduced and the total weight of the device made relatively low. The efficiency of the device can be rendered good, and the manufacturing costs of the device are reasonable. Reducing the weight also decreases energy consumption, which is of great significance for instance in electrically driven vehicles and in aircrafts, in particular.

The idea of an embodiment is that the charge current circuit, in the encapsulation or some other structure thereof, contains ferromagnetic material or some other material suitable for controlling the field lines of the magnetic field and/or intensifying the magnetic field and acting as part of the magnetic circuit. Thus, the charge current circuit further possesses a function that intensifies the magnetic field. Accordingly, the total weight of the device can be further rendered lower than previously. Furthermore, this being so, the charge current circuit may operate as part of the bearing structure of the device, such as an aircraft or a vehicle, thus further decreasing the total weight and energy consumption of the solution.

### BRIEF DESCRIPTION OF THE FIGURES

The invention will be described in more detail in the accompanying drawings, wherein

FIG. 1 schematically shows a partially cross-sectional side view of an electric motor,

FIG. 2 schematically shows a charge current circuit,

FIGS. 3a and 3b schematically show another charge current circuit,

FIG. 4 schematically shows a third charge current circuit,

FIG. 5 schematically shows a detail of the charge current circuit of FIG. 4,

FIG. 6 shows an equivalent circuit of a charge current circuit,

FIG. 7 schematically shows a partially cross-sectional side view of an aircraft,

FIG. 8 schematically shows folded electrodes,

FIG. 9 schematically shows a power unit,

FIG. 10 schematically shows a rod battery adapted to a charge current circuit embodiment,

FIG. 11 schematically shows a charging circuit,

FIG. 12 schematically shows another power unit seen obliquely from the front,

FIG. 13 schematically shows a partially cross-sectional side view of the solution of FIG. 12,

FIG. 14 schematically shows a cross-sectional end view of an actuator,

FIG. 15 shows a top view of the charge current circuit of the actuator of FIG. 14,

FIG. 16 shows a top view of electrodes,

FIG. 17 shows an end view of the electrodes of FIG. 16, and

FIG. 18 schematically shows a cross-sectional end view of part of a cylindrical embodiment.

In the figures, some embodiments of the invention are shown in a simplified manner for the sake of clarity. In the figures, like parts are denoted with like reference numerals.

### DETAILED DESCRIPTION OF THE INVENTION

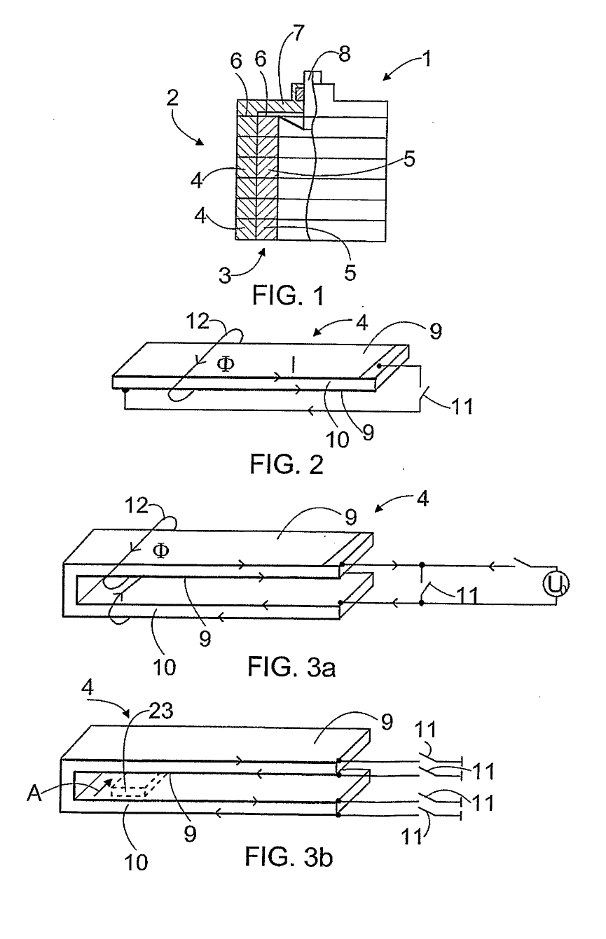

FIG. 1 shows an electric motor 1. The electric motor 1 comprises a stator 2 and a rotor 3 disposed on the inside thereof and able to rotate with respect to the rotor 2.

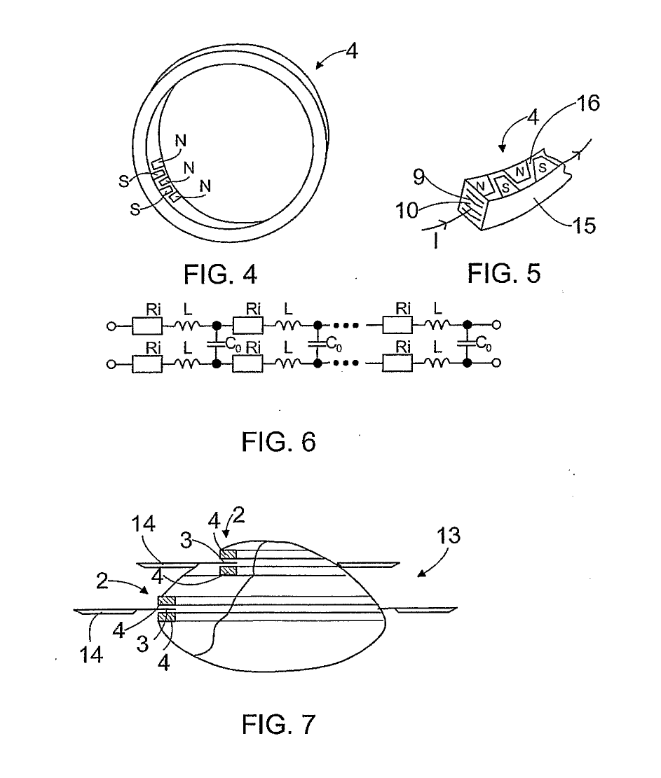

The stator 2 is composed of charge current circuits 4. The charge current circuits 4 are such that, when switched on, they induce an electromagnetic field. The structure of the charge current circuits 4 may be similar to the one illustrated in FIGS. 4 and 5, for example.

The rotor 3 is composed of modules 5. The structure of the modules 5 may be similar to that of the charge current circuits 4 constituting the stator 2. Control current circuits 6 may be integrated as part of the structure of the stator 2 and the rotor 3. The charge current circuits 4 are controlled in such a manner that they generate an electromagnetic field by the action of which the rotor 3 rotates. An embodiment of the invention may indeed be described such that, in the electric motor, the winding of the rotor and/or the stator and the current source are replaced with a charge current circuit, i.e. no current source and a winding separate therefrom are required for generating the magnetic field, but the charge current circuit as such serves as the current source, generating the electromagnetic field producing force and/or movement. The modules 5 constituting the rotor 3 may also be conventional permanent magnet solutions or other solutions known in motor engineering.

The stator 2 is fixedly arranged in a flange 7, and the rotor 3 is connected to a shaft 8. The shaft 8 is bearing-mounted to the flange 7.

FIG. 2 shows a basic principle of a charge current circuit 4. The charge current circuit 4 comprises electrode layers 9 and between them an electrolyte layer 10. In addition, solid or porous insulation material layers may be arranged between the electrode layers and they may be called insulation materials.

When a schematically shown switch 11 is on, current passes in accordance with the arrows illustrated in FIG. 2 thus inducing a magnetic field illustrated with reference numeral 12. FIG. 3a illustrates a charge current circuit 4 having a wound structure. There may also be more than one wound layer. FIG. 3a also illustrates the coupling of an external charge current circuit U₀ to the current source. If the intention is for the charging function not to generate an electric field, current may be supplied during the charging in a manner making it pass in opposite directions in the electrode layers 9. This being so, the embodiment illustrated in FIG. 3b, for example, may be used, wherein connectors and switches 11 are arranged at both ends of the electrodes 9. Accordingly, this embodiment comprises four switches 11, and by controlling them, the current can be caused to pass in the desired direction in the different electrodes 9.

FIGS. 4 and 5 illustrate a structure usable as the charge current circuit in the solution of FIG. 1. The charge current circuit 4 is arranged in the shape of a ring. Electrodes 9 may circulate the entire circumference providing a plurality of layers and, thus, a strong magnetic field. An advantage of a ring-shaped charge current circuit is that the ends of the electrodes 9 can be arranged close to each other, whereby long wirings are not required to and from the switches.

An encapsulation 15 of the charge current circuit may be of silicon steel plate or another suitable ferromagnetic material, for example. The encapsulation 15 is continuous on other sides of the charge current circuit except for the inner circumference of the ring, wherein the encapsulation comprises strips separated from each other with epoxy resin 16 or another suitable insulating material. The encapsulation 15 constitutes part of the magnetic circuit. The poles of the magnetic field are located in an alternating order on the inner circumference of the ring. In FIGS. 4 and 5, the poles of the magnetic field are illustrated by markings N and S. In the other figures, too, markings N and S illustrate the poles of the magnetic field.

The encapsulation 15 may be protected with a film layer, for example, for avoiding corrosion in the device. The charge current circuit may also be a ferrite core, around which the electrode layers are wound.

FIG. 6 shows an electric model of a charge current circuit. The model describes a solution having longitudinal electrodes. In the model, capacitors C₀ represent the capacitance of the charge part of the charge current circuit, resistances Rᵢ losses and inductances L the entire magnetic circuit including iron. The model describes the impedance generated by the entity. The impedance is evenly distributed and is by nature of the transmission line type, which is the most preferable solution also as regards current control. The end of each electrode may be provided with semiconductor switches, which may be controlled in the desired manner. At a minimum, one switch for connecting the opposite ends of the electrodes together is sufficient, whereby the charge begins to discharge. The inductance of the circuit is high, whereby, as the switch is on, the current starts to increase at a rate restricted by the inductance and, as the switch is switched on, the passage of the current breaks. However, in this solution, no harmful flyback voltage is generated, since the impedance of the circuit is of the transmission line type. By using so-called chopper control, the desired control frequency and wavelength may be supplied to the motor at the desired current and power. By integrating the semiconductor switches to the current sources, no transmission losses are generated in the power wirings, since they are not required. The resonance frequency of the current circuit may also be used in the control, whereby the best efficiency is achieved.

FIG. 7 is a top view of a round aircraft 13. Stator units 2 are ring-shaped and serve as an essential part of the bearing structure and decisively lighten the weight of the device. Since the power transmission is evenly distributed to the entire circumference, a small power density and light structures may be used. The control of the charge current circuits 4 of the stator may be divided into a plurality of different blocks in a manner allowing the field strengths achieved to be controlled separately. Between the stators 2, a rotor 3 rotates, which may comprise permanent magnets, for example.

The rotation of the rotor 3 may be controlled by means of current feedback in such a manner that the rotor ring rotates between the stator poles 2 floating without contact, i.e. so-called magnet levitation is used in this case. Rotor blades 14 are fastened to the rotor ring 3. The device may operate also regeneratively in such a manner that as wind rotates the rotors, the magnetic poles of the rotor ring 3 generate a charge in the charge current circuits 4 of the stators 2. In this manner, an extremely light aircraft, battery or fuel cell driven, for example, may be manufactured that consumes little energy and wherein charging may be performed by means of solar or wind energy.

The current-generating and/or current-charging property of the charge current circuit may be similar to the battery, fuel cell, solar cell, thermocouple, pile or supercapacitor principle or another solution suitable for the purpose or a combination of two or more techniques. Typically, the charge current circuit is composed of electrode layers, which may be manufactured also from long strips. Typically, an electrolyte layer is arranged between the electrode layers, and, depending on the application, the charge part may be composed of a plurality of different layers. The electrode layers may be parallel, such as in a wound structure, or the electrodes and the other necessary layers may be stacked on top of each other. In this case, no separate electrode layers are actually required, but the current passes across the different layers and the elements thus obtained are connected in series through so-called bipolar layers. This technique is generally used in fuel cells, for example, in which case the terminal voltage of the stacked element is typically several hundreds of volts and the current may be several hundreds or thousands amperes. Such a current achieves maximum magnetomotive force, even if the element constituted only one layer in the magnetic circuit. Another alternative is to wind the electrode layers onto a spool, whereby they may generate a higher inductance. Preferably, the current passes in the same direction in both electrode layers for maximum inductance to be generated. The ferromaterial, generally used as part of a motor, may serve as part of said inductance.

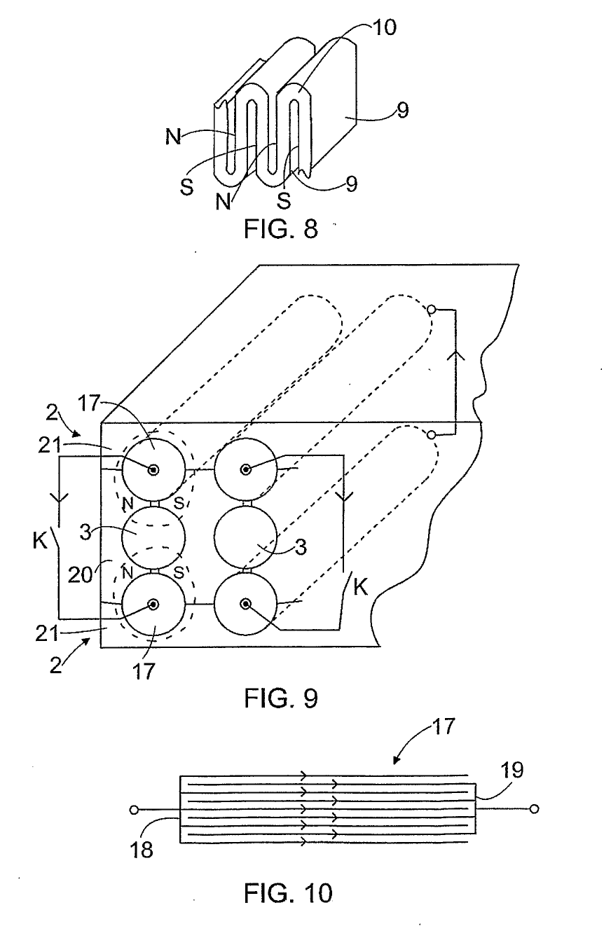

In addition to that shown in the figure, the structure of the charge current circuit may be coaxial or flat cable type, for example, whereby the layer that has inferior electrical conductivity constitutes the outer jacket and an insulating layer is arranged on top thereof, and the necessary number of layers is wound into the bodies of the rotor and/or the stator. The electrode layers may be folded to generate adjacent magnetic circuit poles, as is shown in FIG. 8.

Either the rotor or the stator or both are composed of a charge current circuit. Correspondingly, either the rotor or the stator may have a permanent magnet structure, for example, or it may be composed of a conventional current circuit. The rotor unit and/or the stator unit may be arranged removable for charging, for example.

The control current circuits 6 may be integrated into the rotor and/or the stator. When desired, the control current circuits 6 may be wirelessly controlled.

In the solution presented, very many different motor principles may be applied. Accordingly, the solution may operate for instance with the conventional 3-phase principle or for instance with the reluctance motor principle, whereby no permanent magnets at all are required. The charge current circuit 4 may be in a rotating rotor, allowing it to be controlled with a wireless signal or a modulated signal coming through the stator. There may be several parallel stator-rotor units, allowing the pole number and/or the power of the motor to be increased.

Both the stator and the rotor may be composed of charge current circuits having a corresponding type of structure, allowing the amount of charge to be maximized with respect to the weight of the device, and all structural modules are preferably similar to each other. The entire motor may also be replaceable for charging. The mass of the rotor may also be utilized as a flywheel. The charge current circuits and the modules constituted thereby may also be replaceable for charging and they may be composed of blocks that are separately controllable.

The stator structures may be manufactured from a silicon steel sheet, for example. In the structure, iron may be used or, instead of iron, ferrite composite materials. The solution is also well suitable for so-called ironless motor applications, wherein the eddy-current principle is applied in the rotor and wherein the rotor is of aluminium, for example. Air-core charging coils may also be used in the stators.

When a high pole number is used, a high frequency may be used, whereby a good efficiency is achieved also in so-called ironless solutions, rendering the devices very light. An aluminium rotor may also be provided with apertures, rendering it still lighter. When ferromaterials are used, the control frequency may be several kilohertz. The motor may have a rotating structure, or the solutions presented may be applied as structural solutions to a linear motor.

FIG. 9 shows a power unit to which so-called rod batteries 17 may be applied as charge current circuits, from which current pulses of several hundreds of amperes can be obtained. It is easy to place the rod batteries 17 in series, generating a higher voltage. The rod batteries 17 constitute current circuits in the stator structure 2, and by closing switches K, a three-phase control, for example, can be produced for controlling the rotors 3 provided with permanent magnets.

The rotors 3 may be synchronized to each other with cog-wheels in order to retain the phasing of the rotors with respect to each other. The solution presented achieves a relatively low and efficient power unit that can be utilized in electric cars, for example. The power unit may be arranged at the rear end of the car, for example. Once the current sources are integrated in this manner as part of the motor to generate the magnetic fields required, an extremely efficient and simple power unit for a car may be manufactured, and significant savings in weight and costs are achieved.

FIG. 10 shows the structure of a rod battery 17 adapted to charge current circuit use. The electrode layers of the anode 18 and the cathode 19 are connected at the ends of the battery, whereby the current passes therein in the same direction when the battery is discharge, and in this way a strong magnetic field can be generated in the surrounding ferromagnetic material, as is shown in FIG. 9. The ferromagnetic structure 20 may be of a ferromagnetic composite, for example. The stator structure 2 may be provided with cover parts 21, whereby the batteries may be replaced by opening said cover parts 21 of the stator structures.

The charge part of the charge current circuit may also be charged and loaded regeneratively. In this case, for instance in a motor application, the magnetic poles of the rotor induce an alternating voltage in the electrodes of the charge current circuit via the stator circuit, and the voltage can be stored as the charge of the charge current circuit by rectification. FIG. 11 shows a current circuit, wherein a positive half-wave of the current induced flows via diode D1 into inductance L2 when switch K2 is closed. Switch K2 is opened, whereby the charge of the inductance is transferred as a charge of the charge part. Correspondingly, during a negative half-cycle, switch K1 is controlled. Switches K1 and K2 may be controlled with the chopper principle, allowing the power generated in the charge part to be regulated in a controlled manner for braking the motor, for example. The charging current passes in opposite directions in the electrode layers, whereby it does not generate a magnetic field.

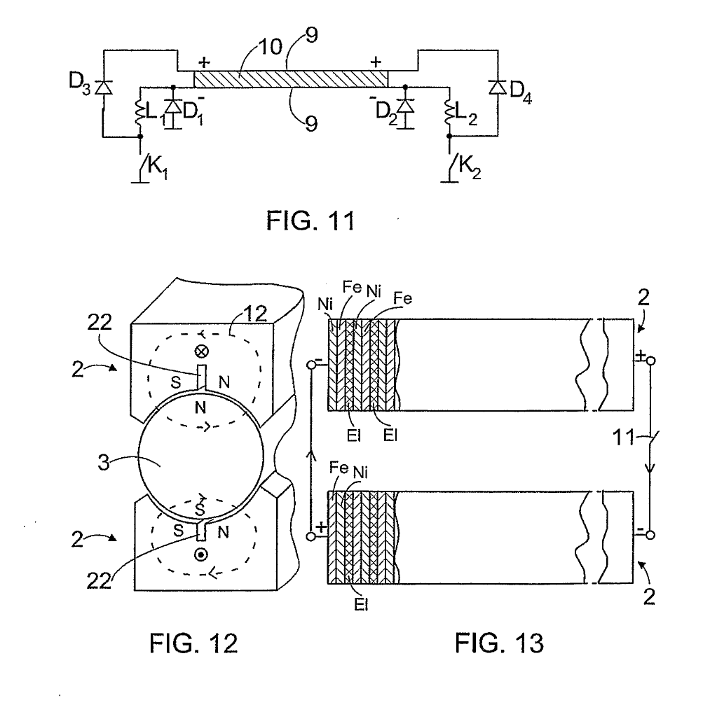

In the invention, it is preferable to apply the so-called iron battery principle, whereby the iron operating as the anode also operates as part of the magnetic circuit. As cathode, nickel, copper, silver or aluminium, for example, may be used. An example of applying the iron battery principle is presented with reference to FIGS. 12 and 13.

FIGS. 12 and 13 show stator sectors 2 composed of interconnected iron-nickel plates (Fe, Ni), which thus constitute both the anode and the cathode, and at the same time operate as so-called bipolar electrodes, which may be stacked in series, whereby electrolyte layers (El) are arranged therebetween. Both nickel and iron are ferromagnetic materials, through which a magnetic field may also pass, and no other ferromagnetic material is necessarily required. The electrolyte layers are between the electrode layers, and the structure is encapsulated within a protective layer.

The structural principles of nickel-metal hybrid batteries or other corresponding battery or fuel cell structures may also be applied, which contain ferromagnetic material. The electrode layers may be arranged either in series or in parallel.

FIGS. 12 and 13 show battery stators 2, between which the rotor 3 rotates. Gaps 22 are provided in the stators 2 for controlling the magnetic field generated. Compared with a conventional motor made from iron plates, the weight of the device is almost the same as the weight of the motor alone in a conventional solution, including the battery function as well. By using porous electrode structures, the weight, power, amount of charge and price of the device may be optimized suitable for the purpose of use. The magnetic field may also pass through adjacent charging modules in multi-phase control, for example. The iron material may also be permanently magnetized to achieve a main magnetic field.

An important advantage of a motor based on a so-called iron battery is that the battery current circuits very well last the entire operating life of the device, and no battery replacement is required. In the invention, previously known battery techniques may be applied either as such or with slight changes. New solutions may also be developed that are better suitable than before for their purpose of use.

As the current source, photoelectric and/or thermoelectric elements may also be applied either as such or together with charge current circuits.

One solution may comprise a charge current circuit and a magnetized element in connection therewith. Such a solution may generate an actuator function that, for instance in connection with a mobile phone, may mean a vibrating call alert. The function is achieved by guiding the current to pass in the same direction in the different electrodes, whereby the charge current circuit and the magnetized element are caused to move relative to each other. This being so, the charge current circuit, for example, may remain in place, while the magnetized element moves, or vice versa.

Furthermore, by the action of external acceleration, the charge current circuit and the magnetized element may be caused to move with respect to one another, and the current and voltage induced thereby may be transferred as the charge of the charge part of the charge current circuit. Thus, for instance shaking or other movement of a mobile phone may be utilized for charging the charge part thereof, such as the battery. When the charge of the current source is being discharged or when its current is being used for another function of the device, the current is guided to pass in opposite directions in the different electrodes, whereby no actuator function is created.

A simple illustration of the actuator function may be presented in such a manner that a permanent magnet is arranged as the magnetized element 23 in connection with the charge current circuit 4 of FIG. 3b. When the current is guided with switches 11 to pass in the same direction in the different electrodes 9, a magnetic field is generated, which moves the permanent magnet in the direction of arrow A or in a direction opposite to that of arrow A, depending on the directions of the currents. In the situation of FIG. 3b, when the currents pass in opposite directions in the different electrodes 9, no magnetic field is generated, and the permanent magnet and the charge current circuit 4 do not move relative to one another.

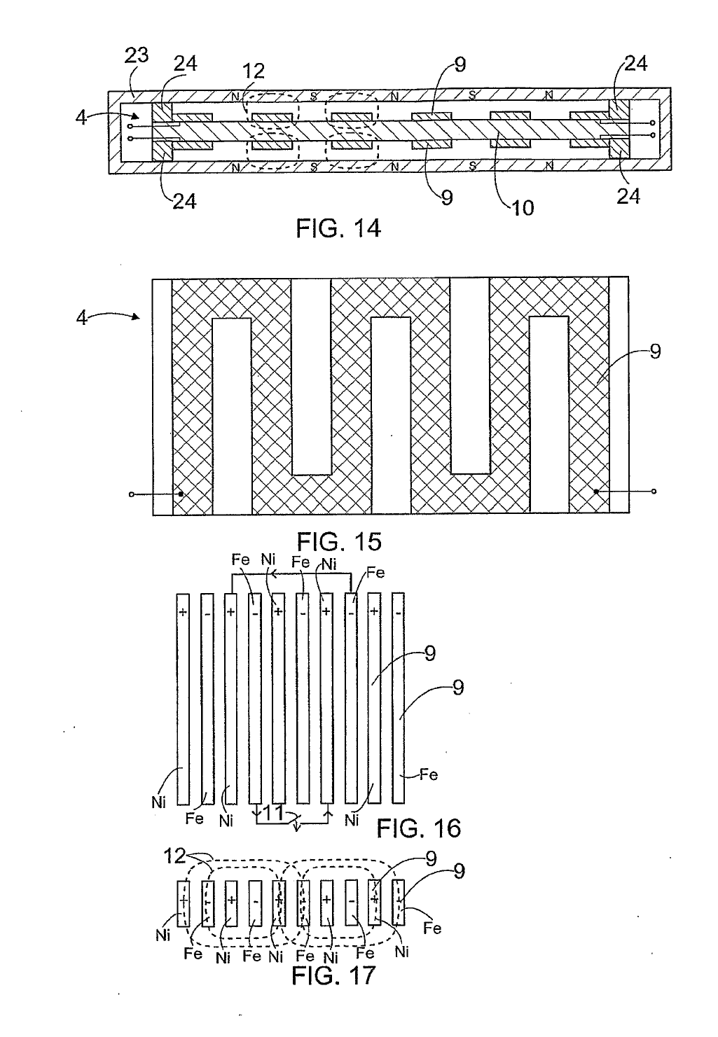

An actuator is also shown in FIG. 14. In the solution of FIG. 14, a casing is arranged outside the charge current circuit 4, the casing serving as the magnetized element 23. The casing and the charge current circuit 4 are interconnected with flexible corner pieces 24. Accordingly, the charge current circuit 4 and the casing 23 are able to move relative to one another. FIG. 15 illustrates the structure of the electrodes of the charge current circuit 4. When current passes is the electrodes 9, magnetic poles are generated in the charge current circuit 4 in the manner illustrated in FIG. 14. At corresponding positions, the casing 23 includes permanent magnet poles, which constitute a magnetic coupling with the magnetic field constituted by the electrode layers 9 of the charge current circuit 4. The electrode 9 may also be designed to differ from FIG. 15 for instance in such a manner that it constitutes a spiral. This being so, the inductance of the electrode is higher than in the embodiment shown in FIG. 15.

FIGS. 16 and 17 show an implementation of the iron-nickel battery principle. FIG. 16 shows a top view of the electrodes, and FIG. 17 shows the same electrodes seen from the ends thereof.

The basic material of the electrodes may be iron. A positive electrode is first nickel-coated and then lined with sintered nickel powder. The negative iron electrode is lined with sintered iron powder. The electrolyte layer may be manufactured from ferromagnetic, porous and isolating, for instance so-called ferrite powder, to which the electrolyte is absorbed.

FIGS. 16 shows the operational principle of the solution, according to which current is controlled to pass first in one direction by utilizing one pair of electrodes, and then back by utilizing another pair of electrodes in such a manner that at least one pair of electrodes, which is not controlled, remains between the pairs of electrodes. Thus, no current passes in the pair of electrodes that is not controlled. FIG. 17 illustrates a magnetic field generated by the pairs of electrodes that are controlled. Accordingly, the magnetic fields pass through the pairs of electrodes not controlled. Thus, the charge current circuit structure also serves as a magnetic circuit, and no separate ferromagnetic magnetic circuit parts are at all required in the stator. Consequently, the device becomes significantly simplified and lightened.

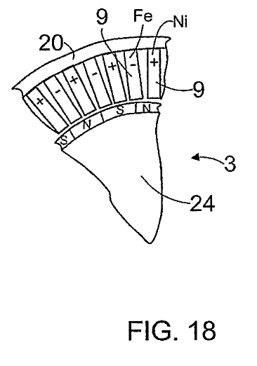

FIG. 18 shows a cross-sectional end view of part of a cylindrical implementation, wherein the structures of the charge current circuits are similar to those illustrated in FIGS. 16 and 17. The rotor 3 includes permanent magnet poles. The rotor 3 could be composed of a hollow steel drum 24, for example, around which permanent magnets are arranged.

In principle, the device may be composed of only one type of component, i.e. a charge current circuit, the device thus comprising two or more similar components in principle. The charge current circuit may serve as a rotor and a stator, allowing the structure to be for instance such that the charge current circuits are annular discs arranged in a superimposed order in such a manner that small air gaps remain therebetween, every second component always serving as a rotor and every second as a stator. This being so, the rotor discs may be interconnected with a shaft, and the stator discs may be connected to the frame or the casing, for example.

In some cases, the features presented in the present application may be used as such, irrespective of other features. On the other hand, if need be, the features disclosed in the present application may be combined to provide different combinations.

The drawings and the related description are only intended to illustrate the idea of the invention. The details of the invention may vary within the scope of the claims.

1. A device for generating a force and/or a movement or for storing the energy of a force and/or a movement by utilizing a magnetic field,
the device comprising a charge current circuit including a charge part and a structure, which generates the magnetic field without a separate winding, whereby a magnetic circuit generates the magnetic field producing the force and/or the movement, or the force and/or the movement produces a variable magnetic field, the current induced by which being conducted to the charge part of the charge current circuit.

2. A device as claimed in claim 1, wherein the structure of the charge current circuit includes material for controlling the field lines of the magnetic field and/or intensifying the magnetic field and acting as part of the magnetic circuit.

3. A device as claimed in claim 2, wherein the device includes electrodes of said material that are controllable to produce current and controllable not to produce current, whereby the electrodes, when they do not produce current, are adaptable to serve as part of the magnetic circuit.

4. A device as claimed in claim 1, wherein the device is arranged as part of the bearing structure of a vehicle.

5. A device as claimed in claim 1, wherein the structure of charge part of the charge current circuit is arranged according to the battery principle.

6. A device as claimed in claim 5, wherein said battery principle is the iron battery principle.

7. A device as claimed in claim 6, wherein the charge part includes bipolar iron-nickel electrodes.

8. A device as claimed in claim 1, wherein the charge part of the charge current circuit is adapted to utilize the fuel cell principle.

9. A device as claimed in claim 1, wherein the structure of the charge part of the charge current circuit is arranged according to the supercapacitor principle.

10. A device as claimed in claim 1, wherein the charge current circuit comprises parallel-connected and/or wound electrodes.

11. A device as claimed in claim 1, wherein the charge current circuit comprises sequentially stacked electrodes in series.

12. A device as claimed in claim 1, wherein the device includes a magnetized element, the charge current circuit and the magnetized element being movable with respect to one another.

13. A device as claimed in claim 12, wherein the charge current circuit includes electrodes in at least two layers, the current passing in the electrodes being controllable to pass in the same direction in the different electrodes for moving the charge current circuit and the magnetized element with respect to one another, the current being controllable to pass in opposite directions in the different electrodes for utilizing the current of the charge current circuit without a mutual movement of the charge current circuit and the magnetized element.

14. A method of generating a force and/or a movement or for storing the energy of a force and/or a movement, the method utilizing a magnetic field and comprising generating the magnetic field with a charge current circuit including a charge part and a structure, which generates the magnetic field without a separate winding, whereby either a magnetic circuit is used to generate the magnetic field producing the force and/or the movement, or the force and/or the movement produces a variable magnetic field, the current induced by which being conducted to the charge part of the charge current circuit.

15. A method as claimed in claim 14, further comprising moving the charge current circuit and a magnetized element in connection therewith relative to one another.

16. A method as claimed in claim 15, the charge current circuit including electrodes in at least two layers, the charge current circuit and a magnetized element being moved with respect to one other by controlling the current passing in the different electrodes to pass in the same direction, and using the current of the charge current circuit without a mutual movement of the charge current circuit and the magnetized element by controlling the current to pass in opposite directions in the different electrodes.
